(19) United States
(12) Patent Application Publication
(10) Pub. No.: US 2021/0123217 A1
(43) Pub. Date: Apr. 29, 2021

(54) MAINTENANCE ASSISTANCE DEVICE, WORK MACHINE, MAINTENANCE ASSISTANCE SYSTEM, AND MAINTENANCE ASSISTANCE METHOD

(71) Applicant: KOMATSU LTD., Tokyo (JP)

(72) Inventors: Yosuke OKUMURA, Tokyo (JP); Katsunaga KASHIMA, Tokyo (JP)

(21) Appl. No.: 17/055,282

(22) PCT Filed: Mar. 12, 2019
(86) PCT No.: PCT/JP2019/009996

§ 371 Date: Nov. 13, 2020

(30) Foreign Application Priority Data
Jun. 27, 2018 (JP) 2018-121867

(51) Int. Cl. E02F 9/26; G06Q 10/00; G07C 5/00

(52) U.S. Cl. CPC E02F 9/26; E02F 3/96; G07C 5/006; G06Q 10/20

(57) ABSTRACT

A maintenance assistance device includes an attachment use time acquisition unit and a maintenance estimate time calculation unit. The attachment use time acquisition unit acquires a time during which an attachment is used. The attachment is mounted on a work machine and is different from a bucket. The maintenance estimate time calculation unit calculates a maintenance estimate time of a consumable equipped with the work machine based on the time during which the attachment is used.

### CROSS-REFERENCE TO RELATED APPLICATIONS

This application is a U.S. National stage application of International Application No. PCT/JP2019/009996, filed on Mar. 12, 2019. This U.S. National stage application claims priority under 35 U.S.C. § 119(a) to Japanese Patent Application No. 2018-121867, filed in Japan on Jun. 27, 2018, the entire contents of which are hereby incorporated herein by reference.

### BACKGROUND

### Field of the Invention

The present invention relates to a maintenance assistance device, a work machine, a maintenance assistance system, and a maintenance assistance method.

### Background Information

Japanese Unexamined Patent Application, First Publication No. 2000-034748 discloses a maintenance period display device for a civil engineering and construction machine, the maintenance period display device turning on a key switch to perform an arithmetic operation and integration on a time during which power of a battery is supplied to power of a controller, that is, a controller power-on time using the controller and displaying a maintenance period by considering the controller power-on time as an actual machine operating time.

### SUMMARY

There is a case where a work machine, such as a hydraulic excavator, performs work different from normal work when an attachment, such as a breaker, is replaced with a bucket. When work using the attachment is performed, there is a case where a hydraulic system dedicated to the attachment is used, in addition to a hydraulic system that performs a basic operation of the work machine. Therefore, there is a case where loads on various consumables (hydraulic oil, a hydraulic oil element, and the like) become large, compared to normal work. Therefore, in a method according to the related art, there is a problem in that it is not possible to appropriately recognize a maintenance period of the consumable when the work is performed with the mounted attachment.

An object of the present invention is to provide a maintenance assistance device, a work machine, a maintenance assistance system, and a maintenance assistance method which can appropriately calculate the maintenance period of the consumable even when a work which has a larger load than usual is performed with the mounted attachment.

According to one aspect of the present invention, a maintenance assistance device includes: an attachment use time acquisition unit configured to acquire a time during which an attachment which is mounted on a work machine and is different from a bucket is used; and a maintenance estimate time calculation unit configured to calculate a maintenance estimate time of a consumable equipped with the work machine based on the time during which the attachment is used.

According to at least one of the above aspects, it is possible to appropriately calculate a maintenance period even when a work which has a larger load than usual is performed with a mounted attachment.

### BRIEF DESCRIPTION OF DRAWINGS

FIG. 1 is a diagram representing an overall configuration of a hydraulic excavator according to a first embodiment.

FIG. 2 is a diagram representing a configuration of a driver's seat of the hydraulic excavator according to the first embodiment.

FIG. 3 is a diagram representing a functional configuration of the hydraulic excavator according to the first embodiment.

FIG. 4 is a diagram representing an operation of a maintenance assistance device according to the first embodiment.

FIG. 5 is a diagram representing the operation of the maintenance assistance device according to the first embodiment.

FIG. 6 is a diagram representing the operation of the maintenance assistance device according to the first embodiment.

FIG. 7 is a diagram representing an operation of a maintenance assistance device according to a modified example of the first embodiment.

FIG. 8 is a diagram illustrating a configuration of a controller according to the first embodiment and the modified example of the first embodiment as a computer.

### DETAILED DESCRIPTION OF EMBODIMENT(S)

### First Embodiment

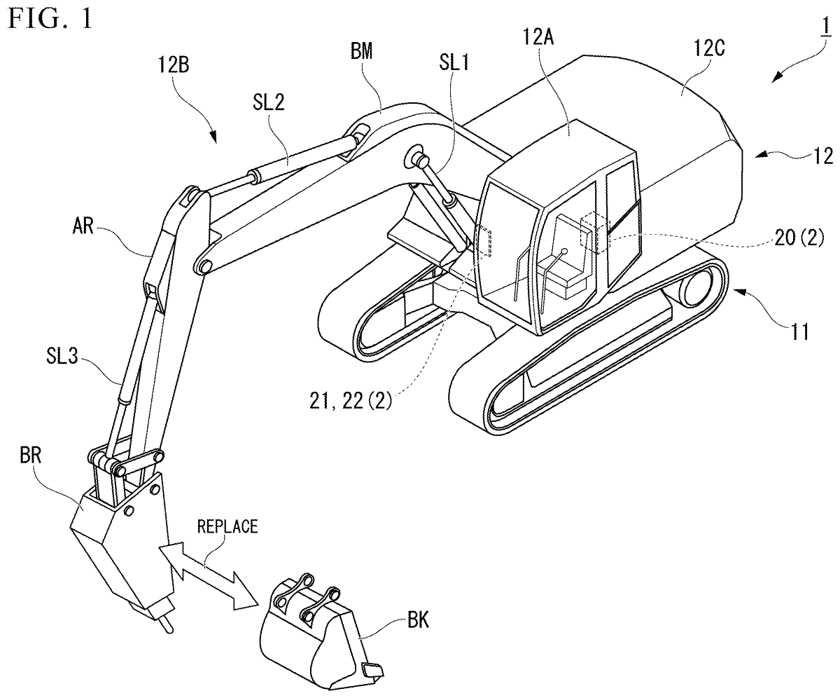

Hereinafter, a maintenance assistance device according to a first embodiment and a hydraulic excavator equipped with the same will be described in detail with reference to FIGS. 1 to 6.

### (Overall Configuration of Hydraulic Excavator)

FIG. 1 is a diagram representing an overall configuration of a hydraulic excavator according to the first embodiment.

A hydraulic excavator 1 is one aspect of a work machine and excavates and levels earth or the like at a work site or the like.

As shown in FIG. 1, the hydraulic excavator 1 includes an undercarriage 11 for traveling, and an upper swing body 12 installed at an upper part of the undercarriage 11 to be swingable. In addition, the upper swing body 12 is provided with a cab 12A, work equipment 12B, a counterweight 12C, and the like.

The cab 12A is a place where an operator of the hydraulic excavator 1 gets on and performs a manipulation. The cab 12A is installed, for example, on a left side part of a front end portion of the upper swing body 12. A detailed configuration of the cab 12A will be described later.

The work equipment 12B includes a boom BM, an arm AR, and a bucket BK. The boom BM is mounted on the front end portion of the upper swing body 12. In addition, the arm AR is attached to the boom BM. In addition, the bucket BK is attached to the arm AR. In addition, a boom cylinder SL1 is attached between the upper swing body 12 and the boom BM. The boom BM can be operated with respect to the upper swing body 12 by driving the boom cylinder SL1. An arm cylinder SL2 is attached between the boom BM and the arm AR. The arm AR can be operated with respect to the boom BM by driving the arm cylinder SL2. A bucket cylinder SL3 is attached between the arm AR and the bucket BK. The bucket BK can be operated with respect to the arm AR by driving the bucket cylinder SL3.

In the embodiment, as shown in FIG. 1, a breaker BR is mounted at a tip end of the work equipment 12B instead of the bucket BK. The breaker BR is one aspect of an attachment with respect to the hydraulic excavator 1 and is a mounting component that is mounted through replacement with the bucket BK when performing a special work such as crushed stone crushing or rock excavation.

In a work using the breaker BR, in addition to a four-axis operation (extending and retracting operations of the boom cylinder SL1, the arm cylinder SL2, the bucket cylinder SL3, and a swing operation of the upper swing body 12) which is a basic operation of the hydraulic excavator 1, a striking operation is performed by the breaker BR. The striking operation by the breaker BR is one aspect of the special operation by the attachment.

As shown in FIG. 1, the hydraulic excavator 1 is equipped with a maintenance assistance device 2. The maintenance assistance device 2 includes a controller 20, a monitor 21, and a buzzer 22. A detailed configuration and a function of the maintenance assistance device 2 will be described later.

### (Configuration of Cab of Hydraulic Excavator)

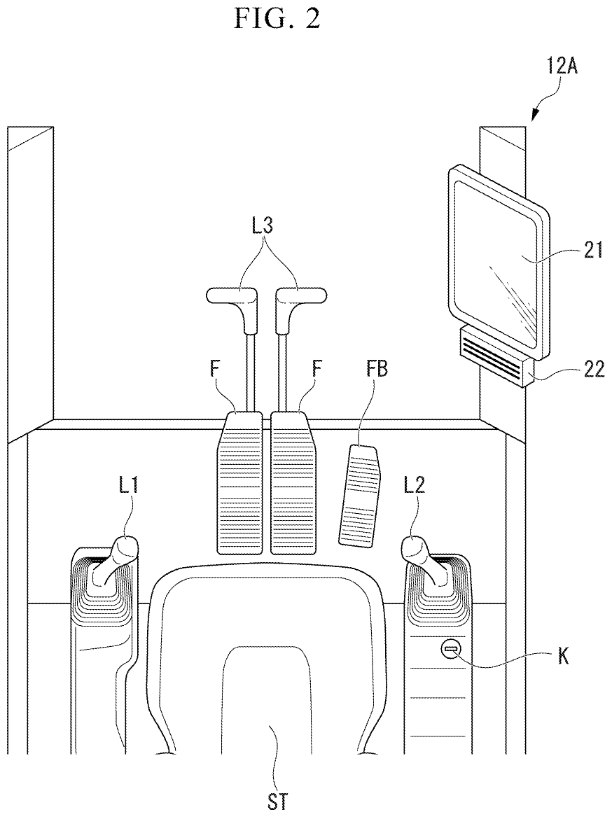

FIG. 2 is a diagram representing a configuration of the cab of the hydraulic excavator according to the first embodiment.

Manipulation levers L1 and L2 are disposed on the left and right of an operator seat ST in the cab 12A. The manipulation levers L1 and L2 are manipulation mechanisms for controlling the swing operation of the upper swing body 12 and the operations of the boom BM, the arm AR, and the breaker BR (bucket BK) of the work equipment 12B.

A foot pedal F and an attachment foot pedal FB are disposed on a floor surface in front of the operator seat ST in the cab 12A. The foot pedal F and a traveling lever L3 are manipulation mechanisms for performing operation control of the undercarriage 11, that is, travel control of the hydraulic excavator 1. In addition, the attachment foot pedal FB is a manipulation mechanism for performing a striking operation by the breaker BR. The attachment foot pedal FB according to the embodiment is one aspect of an attachment manipulation mechanism.

The operator first fixes the breaker BR to a desired position and posture by manipulating the manipulation levers L1 and L2, and continuously performs the striking operation by stepping the attachment foot pedal FB, when a work using the breaker BR is performed.

Here, when the hydraulic excavator 1 performs a normal work with the mounted bucket BK, the operation performed by the hydraulic excavator 1 is only the above-described basic operation based on the manipulation of the manipulation levers L1 and L2. On the other hand, when a crushing work or the like is performed with the mounted breaker BR, the operation performed by the hydraulic excavator 1 further includes a striking operation based on the stepping of the attachment foot pedal FB, in addition to the above-described basic operation. Therefore, the work performed with the mounted breaker BR has a larger load on the hydraulic system and the consumables than the normal work performed with the mounted bucket BK.

Note that, the “normal work” performed by the work machine is a work mainly performed by the work machine and is a work performed by using an attachment that is standardly mounted on the work machine. When the work machine is the hydraulic excavator 1 as in the embodiment, the normal work includes a work for excavating, loading, or leveling earth, the work being performed using the bucket BK.

A monitor 21 and a buzzer 22 of the maintenance assistance device 2 are disposed in the cab 12A.

The monitor 21 is an input and output device equipped with a touch sensor-type display. A remaining time or the like until maintenance of various consumables calculated by the controller 20 is displayed on the monitor 21.

Here, the consumable is a component whose original function gradually deteriorates with the operation of the hydraulic excavator 1 and is a component on which it is necessary to periodically perform “maintenance” that is a recovery measure for the function. In the embodiment, the consumable includes, for example, work oil, a work oil element, a pilot filter element, a breaker additional filter, and the like, and the consumable is replaced as maintenance. Note that, aspects of the consumable and maintenance are not limited to the above description. For example, one aspect of the consumable may be a tank, and one aspect of maintenance performed on the tank may be washing or cleaning.

The buzzer 22 issues an alert to provide a notification to the operator when the remaining time for a certain consumable becomes equal to or less than a predetermined value.

An ignition key K is disposed on a right side portion of the operator seat ST. The operator who gets on the hydraulic excavator 1 first turns on the ignition key K, that is, performs a key-on manipulation. As a result, an entire system including an engine, a pump, the maintenance assistance device 2, and the like of the hydraulic excavator 1 is activated. In addition, when the work by the hydraulic excavator 1 is finished, the ignition key K is turned off, that is, a key-off manipulation is performed to stop the operation of the entire system of the hydraulic excavator 1. (Functional Configuration of Maintenance Assistance Device)

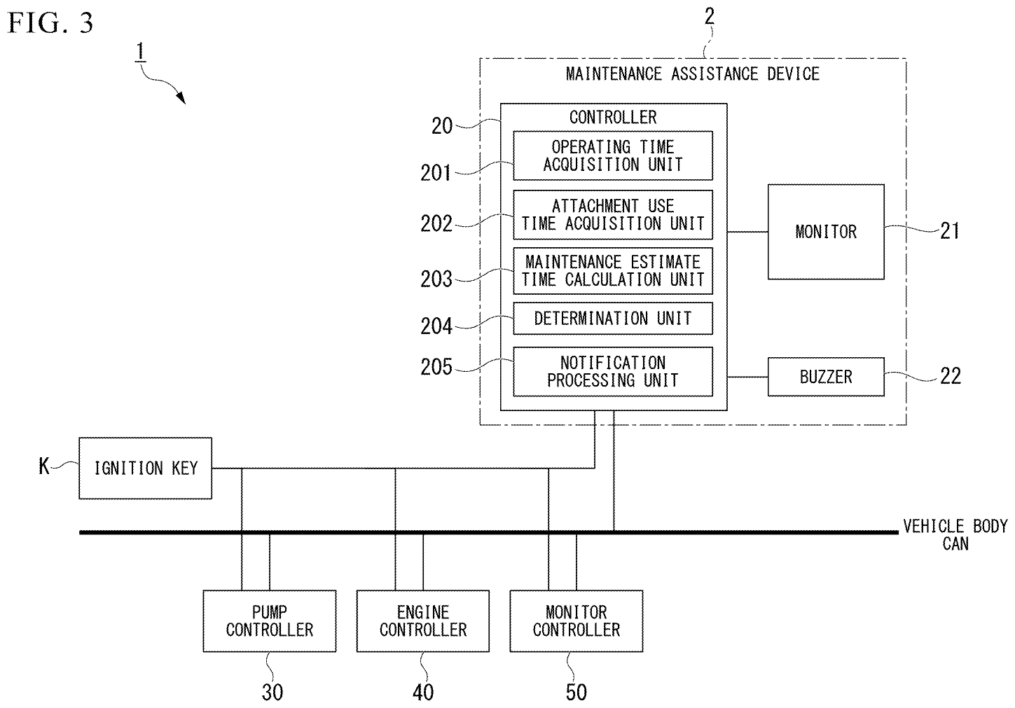

FIG. 3 is a diagram representing a functional configuration of the maintenance assistance device or the like according to the first embodiment.

As shown in FIG. 3, the maintenance assistance device 2 includes the controller 20, the monitor 21, and the buzzer 22.

The controller 20 controls the entire operation of the maintenance assistance device 2. The controller 20 according to the embodiment includes a CPU inside. Further, the CPU operates according to a dedicated program to exhibit various functions which will be described later. Note that, in another embodiment, the controller 20 may include a customized Large Scale Integrated Circuit (LSI), such as a Programmable Logic Device (PLD), in addition to or instead of the above configuration. An example of the PLD includes a Programmable Array Logic (PAL), a Generic Array Logic (GAL), a Complex Programmable Logic Device (CPLD), and a Field Programmable Gate Array (FPGA). In this case, some or all of the functions implemented by a processor may be implemented by the integrated circuit.

Specifically, the controller 20 exhibits functions as an operating time acquisition unit 201, an attachment use time acquisition unit 202, a maintenance estimate time calculation unit 203, a determination unit 204, and a notification processing unit 205.

The operating time acquisition unit 201 acquires an accumulated value of a time (operating time) during which the hydraulic excavator 1 is operated. Specifically, the operating time acquisition unit 201 accumulates, as the accumulated value of the operating time, a time from when the ignition key K is manipulated to be turned on to start the engine to when the engine is manipulated to be turned off to stop the engine. Note that, the accumulated value of the operating time of the engine from a stage when the hydraulic excavator 1 is new is also referred to as Service Meter Reading (SMR).

The attachment use time acquisition unit 202 acquires an accumulated value of a time (breaker use time) in which the breaker BR mounted on the hydraulic excavator 1 and different from the bucket BK is used. Specifically, the attachment use time acquisition unit 202 acquires the accumulated value of the time during which the breaker BR is used by accumulating an input time (stepping time) to the attachment foot pedal FB by the operator.

The maintenance estimate time calculation unit 203 performs an arithmetic operation on a maintenance estimate time of the consumable based on the time during which the breaker BR is used. Here, the maintenance estimate time is information serving as a standard for the maintenance period of the consumable, and, in the present embodiment, is assumed as a “remaining time” that indicates a time in which the consumable can be further used from a present time point.

In particular, the maintenance estimate time calculation unit 203 according to the present embodiment performs the arithmetic operation on the remaining time of the consumable based on the accumulated value of the time during which the hydraulic excavator 1 is operated and the accumulated value of the time during which the breaker BR is used.

The determination unit 204 determines whether or not to replace (maintenance) the consumable based on the remaining time calculated by the maintenance estimate time calculation unit 203.

The notification processing unit 205 notifies a worker of the remaining time of each consumable calculated by the maintenance estimate time calculation unit 203. In the present embodiment, the notification processing unit 205 displays remaining times of various consumables on the monitor 21. In addition, the notification processing unit 205 performs an alert process using the monitor 21, the buzzer 22, and the like when the remaining time of the consumable is equal to or less than a predetermined determination threshold value.

As shown in FIG. 3, the hydraulic excavator 1 includes a pump controller 30, an engine controller 40, and a monitor controller 50, and the like, which are system controllers other than the maintenance assistance device 2.

The controller 20, the pump controller 30, the engine controller 40, and the monitor controller 50 are communicably connected to each other through CAN in a vehicle body.

In addition, the controller 20, the pump controller 30, the engine controller 40, and the monitor controller 50 are connected to the ignition key K. When the operator performs the manipulation on the ignition key K, a key-on signal or a key-off signal based on the manipulation is input to each of the controller 20, the pump controller 30, the engine controller 40, and the monitor controller 50.

### (Operation of Maintenance Assistance Device)

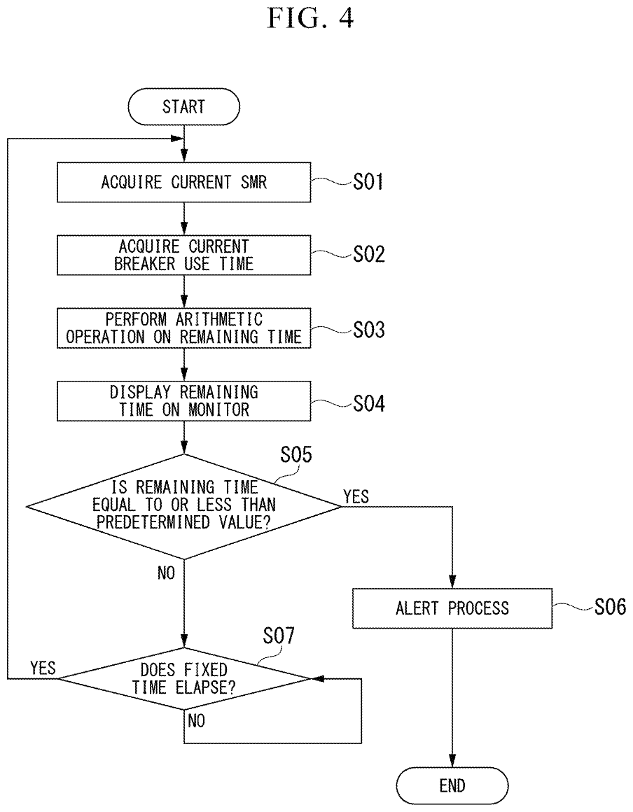

FIGS. 4 to 7 are diagrams representing the operation of the maintenance assistance device according to the first embodiment.

FIG. 4 represents a process flow executed by the controller 20 of the maintenance assistance device 2. The process flow shown in FIG. 4 is started from a time point when the operator performs the key-on manipulation on the ignition key K and the activation of the controller 20 is completed and is repeatedly executed until the key-off manipulation is performed on the ignition key K and the operation of the controller 20 is stopped.

First, the operating time acquisition unit 201 of the controller 20 acquires a current SMR (step S01). The current SMR is the SMR at a current time point. As described later, the current SMR is updated every moment during the operation of the controller 20 by the process in step S01 being repeatedly executed.

Next, the attachment use time acquisition unit 202 of the controller 20 acquires an accumulated value of the current breaker use time (step S02). The accumulated value of the current breaker use time is an accumulated value of the breaker use time from the stage when the hydraulic excavator 1 is new at the current time point. In other words, the accumulated value of the current breaker use time is an accumulated value of a time during which the attachment foot pedal FB is stepped from the stage when the hydraulic excavator 1 is new at the current time point. The accumulated value of the current breaker use time is also a parameter that is updated every moment during the operation of the controller 20.

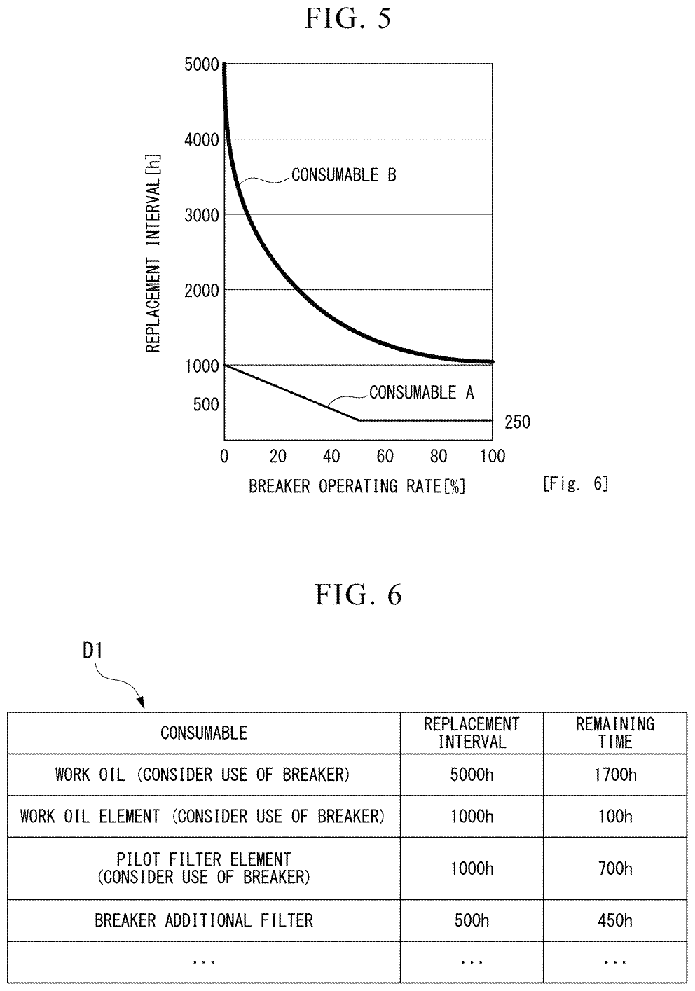

Next, the maintenance estimate time calculation unit 203 of the controller 20 performs the arithmetic operation on the remaining time for each consumable based on the current SMR acquired in step S01 and the accumulated value of the current breaker use time acquired in step S02 (step S03). Hereinafter, a specific process in step S03 performed by the maintenance estimate time calculation unit 203 will be described in detail with reference to FIG. 5.

FIG. 5 is a graph representing a relationship between a replacement interval and a breaker operating rate for consumables.

The breaker operating rate is a ratio of the accumulated value of the breaker use time to an accumulated value of the operating time from when the use of consumable is started. The replacement interval is an interval from when the use of consumable is started to when the replacement is performed. The replacement interval is an example of a maintenance interval.

As being clear from viewing FIG. 5, the replacement intervals of various consumables are defined to be set to be short as the breaker operating rate increases. A reason for this is that a load on the consumable increases as the breaker operating rate increases.

Therefore, the controller 20 (maintenance estimate time calculation unit 203) according to the present embodiment performs the arithmetic operation on the remaining time according to Equation (1).

Equation (1)

Remaining time=replacement interval−(Current SMR−SMR at time of previous replacement)×α−(Accumulated value of current breaker use time−Accumulated value of breaker use time at time of previous replacement)×β (1)

In Equation (1), an SMR at the time of previous replacement is an SMR at a time point when the consumable is replaced. (Current SMR−SMR at time of previous replacement) represents the accumulated value of the operating time from the time point when the consumable is replaced.

In addition, in Equation (1), the accumulated value of the breaker use time at the time of the previous replacement is the accumulated value of the breaker use time at the time point when the consumable is replaced. (Accumulated value of current breaker use time−Accumulated value of breaker use time at time of previous replacement) represents the accumulated value of the breaker use time from the time point when the consumable is replaced.

In addition, as shown in the Equation (1), a first coefficient α is a coefficient which is multiplied by “Current SMR−SMR at time of previous replacement”. In addition, a second coefficient β is a coefficient which is multiplied by “Accumulated value of current breaker use time−Accumulated value of breaker use time at time of previous replacement”. The first coefficient α and the second coefficientβ are appropriately determined based on a unique life characteristic of the consumable as shown in FIG. 5.

For example, the work oil, the work oil element, the pilot filter element, or the like, which is one aspect of the consumable, is consumed by a special operation (striking operation) by the attachment, in addition to, by the basic operation of the hydraulic excavator 1. Therefore, for the consumable, setting is performed such that, for example, the first coefficient α=1 and the second coefficient β=3 to 5. On the other hand, the breaker additional filter is a consumable that is consumed only when the breaker BR is used. Therefore, for the consumable, setting is performed such that, for example, the first coefficient α=0 and the second coefficient β=1. Similarly, for a consumable whose remaining time is not affected by the use of the breaker BR, setting is performed such that the first coefficient α=1 and the second coefficient β=0. As described above, the first coefficient α and the second coefficient β can be freely customized for each consumable according to the characteristic of the consumable.

The SMR at the time of the previous replacement and the accumulated value of the breaker use time at the time of the previous replacement used in the Equation (1) are updated according to a predetermined manipulation of the operator when the consumable is actually replaced by the operator. Specifically, when the controller 20 receives the predetermined manipulation from the operator who performs a consumable replacement work, the controller 20 updates the SMR at the time of the previous replacement to the current SMR, and updates the accumulated value of the breaker use time at the time of the previous replacement to the accumulated value of the current breaker use time. As a result, the remaining time is reset.

Returning to FIG. 4, next, the notification processing unit 205 of the controller 20 displays the remaining time calculated in step S03 on the monitor 21 (step S04). Hereinafter, a specific process in step S04 performed by the notification processing unit 205 will be described in detail with reference to FIG. 6.

A remaining time table D1 represented in FIG. 6 is an example of information displayed on the monitor 21 by the notification processing unit 205. In the remaining time table D1, for each consumable, the replacement interval and the remaining time as a result of the process in step S04 are displayed.

Note that, when the arithmetic operation is performed on the remaining time using the breaker use time, the notification processing unit 205 may notify (display) information indicating that the notified (displayed) remaining time is calculated by considering a fact that the attachment (breaker BR) which is different from the bucket BK is used. Specifically, the notification processing unit 205 may display a guidance message (guidance) such as “consider use of breaker” along with the remaining time, as in the remaining time table D1. By doing so, for example, the following effects can be obtained.

That is, when the arithmetic operation is performed on the remaining time using the breaker use time, it is assumed that the remaining time of the consumable decreases at a speed faster than an actual time flow and uncomfortable feeling is given to the operator. Therefore, by displaying the guidance message such as “consider use of breaker” together, it is possible to prevent the uncomfortable feeling about the fact that the remaining time decreases at the speed faster than the actual time flow from being given to the operator.

Returning to FIG. 4, next, the determination unit 204 of the controller 20 determines whether or not the remaining time, which is a result of calculation in step S03, is equal to or less than the predetermined determination threshold value (step S05). When a remaining time of a certain consumable is equal to or less than the predetermined determination threshold value (step S05: YES), the notification processing unit 205 issues an alert for notifying that the remaining time of the consumable is short through the monitor 21 and the buzzer 22 (step S06). In this case, the controller 20 ends the process flow of FIG. 4, together with a process of issuing the alert.

When the remaining time is not equal to or less than the predetermined determination threshold value for any consumable (step S05: NO), the notification processing unit 205 proceeds to a next step without performing the alert process in step S06.

Next, the controller 20 determines whether or not a fixed time (for example, 30 minutes, 1 hour, or the like) elapses (step S07). When the fixed time does not elapse (step S07: NO), the controller 20 waits until the fixed time elapses. When the fixed time elapses (step S07: YES), the controller 20 returns to the process in step SO1 and repeatedly executes the above processes.

### (Effects)

As described above, the maintenance assistance device 2 according to the first embodiment includes the maintenance estimate time calculation unit 203 that performs the arithmetic operation on the remaining time of the consumable equipped with the hydraulic excavator 1, and the attachment use time acquisition unit 202 that acquires the accumulated value of the time during which the attachment (breakers BR) different from the bucket BK is used, the breakers BR being mounted on the hydraulic excavator 1. Further, the maintenance estimate time calculation unit 203 performs the arithmetic operation on the remaining time of the consumable based on the accumulated value of the time (breaker use time) during which the attachment is used.

By doing so, it is possible to appropriately calculate the maintenance period even when the work which has a larger load than usual is performed with the mounted breaker BR.

In addition, the maintenance estimate time calculation unit 203 according to the first embodiment performs the arithmetic operation on the remaining time of the consumable based on the accumulated value of the time (SMR) during which the hydraulic excavator 1 is operated and the accumulated value of the time (breaker use time) during which the attachment is used.

By doing so, it is possible to rationally perform the arithmetic operation on the remaining time of the consumable in consideration of both deterioration in the consumable due to the basic operation of the hydraulic excavator 1 and deterioration in the consumable due to the special operation performed by the attachment.

In addition, the maintenance estimate time calculation unit 203 according to the first embodiment performs the arithmetic operation on the remaining time of the consumable by subtracting a value, which is obtained by multiplying the operating time of the hydraulic excavator 1 by the predetermined first coefficient α, and a value, which is obtained by multiplying the accumulated value of the breaker use time by the predetermined second coefficient β, from the replacement interval of the consumable (see Expression (1)).

By doing so, it is possible to flexibly set an appropriate arithmetic operational equation of the remaining time for each consumable.

In addition, the attachment use time acquisition unit 202 according to the first embodiment acquires the accumulated value of the time during which the breaker BR is used by integrating the input time to a manipulation mechanism for the attachment (attachment foot pedal FB) by the operator.

By doing so, it is possible to easily and accurately acquire the accumulated value of the time during which the breaker BR is used.

### MODIFIED EXAMPLE

Hereinabove, the maintenance assistance device 2 according to the first embodiment is described in detail. However, a specific aspect of the maintenance assistance device 2 is not limited to the above description and various design changes or the like can be added without departing from the scope of the invention.

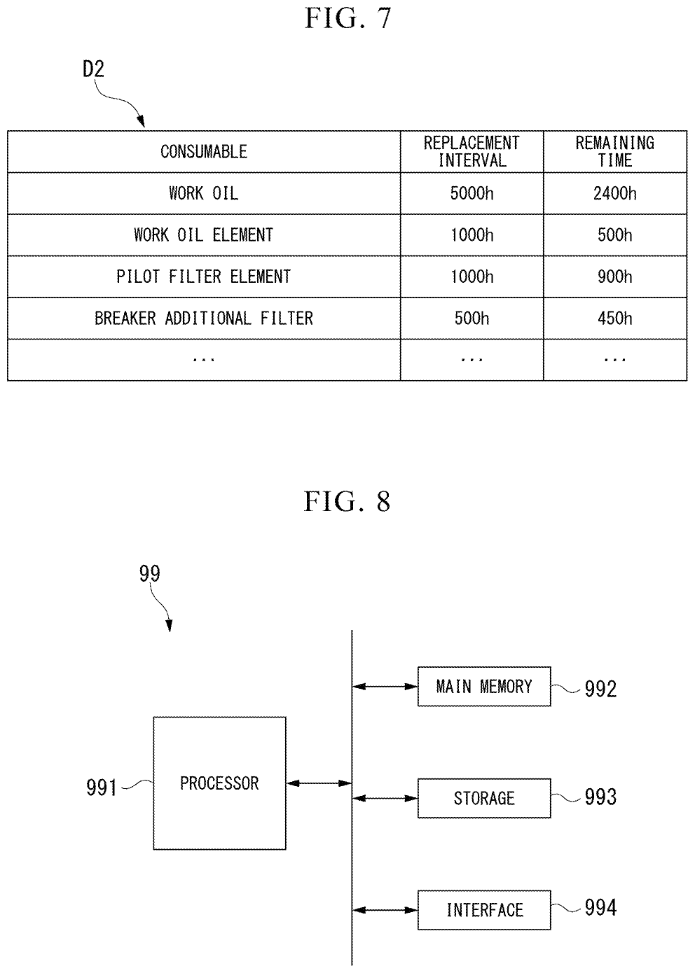

FIG. 7 is a diagram representing an operation of a maintenance assistance device according to a modified example of the first embodiment.

Hereinafter, the specific process in step S04 performed by the notification processing unit 205 according to the modified example will be described in detail with reference to FIG. 7.

A remaining time table D2 shown in FIG. 7 is an example of the information displayed on the monitor 21 by the notification processing unit 205. Similar to the remaining time table D1 (FIG. 6), for each consumable, the replacement interval and the remaining time are displayed in the remaining time table D2. However, the remaining time displayed in the remaining time table D2 is a remaining time calculated without considering the accumulated value of the breaker use time. In other words, the remaining time displayed in the remaining time table D2 is the remaining time calculated by setting the first coefficient α=1 and the second coefficient β=0 in Equation (1). However, for the breaker additional filter that is consumed only when the breaker BR is used, the remaining time is also displayed based on only the accumulated value of the breaker use time in the remaining time table D2.

The controller 20 according to the modified example may cause any one or both of the remaining time table D1 and the remaining time table D2 to be displayed on the monitor 21 according to a predetermined manipulation of the operator.

In this case, the maintenance estimate time calculation unit 203 performs the arithmetic operation on both a first remaining time of the consumable (first maintenance estimate time) based on the accumulated value of the operating time and the accumulated value of the breaker use time and a second remaining time (second maintenance estimate time) of the consumable based on only the accumulated value of the operating time. Here, the first remaining time is the remaining time displayed in the maintenance estimate time table D1, and the second remaining time is the remaining time displayed in the maintenance estimate time table D2.

By doing so, the operator can comprehend both the remaining time (first maintenance estimate time) calculated in consideration of the use of the breaker BR and the remaining time (second maintenance estimate time) when calculated without consideration of the use of the breaker BR.

In addition, although the description is performed such that the attachment use time acquisition unit 202 according to the first embodiment acquires the accumulated value of the time during which the breaker BR is used by integrating the input time to the attachment foot pedal FB, the present invention is not limited to the aspect in another embodiment.

For example, an aspect may be provided in which, when the breaker BR is used, the hydraulic excavator 1 according to another embodiment switches from a normal operation mode using the bucket BK to a breaker use mode using the breaker BR in such a way that the operator manipulates a predetermined mode changeover switch. In this case, the attachment use time acquisition unit 202 may acquire, as the breaker use time, an accumulated value of a time during which the breaker use mode is selected.

In addition, the attachment use time acquisition unit 202 according to another embodiment may acquire the accumulated value of the breaker use time by automatically identifying whether the bucket BK or the breaker BR is mounted at the tip end of the work equipment 12B based on an image of a vehicle-mounted camera or the like and accumulating a time during which the breaker BR is mounted.

In addition, although the description is performed such that the operating time acquisition unit 201 according to the first embodiment acquires a time from when the key-on manipulation with respect to the ignition key K is received to when the key-off manipulation is received as the operating time, the present invention is not limited to the aspect in another embodiment.

For example, the operating time acquisition unit 201 may acquire the accumulated value of the time during which the hydraulic excavator 1 is performing the basic operation as the accumulated value of the operating time.

In addition, although the maintenance assistance device 2 according to the first embodiment only notifies the operator of the hydraulic excavator 1 of the arithmetic operation result of the remaining time for various consumables through the monitor 21 or the like, the present invention is not limited to the aspect in another embodiment. For example, the maintenance assistance device 2 may have a function of sequentially transmitting the arithmetic operation result of the remaining time for various consumables to an external server through a wide area communication network in a wireless manner. By doing so, it is possible to collectively manage the remaining time of the consumables of a plurality of work machines.

In addition, although the description is performed such that, in the maintenance assistance device 2 according to the first embodiment, all of the controller 20 and user interfaces, such as the monitor 21 and the buzzer 22, are equipped with the hydraulic excavator 1, the present invention is not limited to the aspect in another embodiment.

For example, in another embodiment, an aspect may be provided in which various functions of the controller 20 are provided in an external server, a mobile terminal, or the like (hereinafter, simply referred to as an external device) disposed outside the hydraulic excavator 1. In other words, an aspect may be provided in which the maintenance assistance system includes the maintenance assistance device 2 and the hydraulic excavator 1 (work machine), and the maintenance assistance device 2 is installed outside the hydraulic excavator 1.

In this case, the hydraulic excavator 1 has a function of sequentially transmitting state information indicating an operating state (whether or not the engine is operated, whether or not the breaker BR is used, or the like) to the external device that is remotely disposed. The external device calculates the time during which the attachment is used based on a time sequence of the state information received from the hydraulic excavator 1.

In addition, an aspect may be provided in which, in the maintenance assistance system, all of the various functions of the controller 20 (the operating time acquisition unit 201, the attachment use time acquisition unit 202, the maintenance estimate time calculation unit 203, and the notification processing unit 204) are included in the external device, or in which only some of the various functions are included in the external device. The attachment use time acquisition unit 202 is an example of an attachment use time acquisition device. In addition, the maintenance estimate time calculation unit 203 is an example of a maintenance estimate time calculation device.

In addition, although the description is performed such that the maintenance assistance device 2 according to the first embodiment includes the monitor 21 and the buzzer 22, as the user interface, in addition to the controller 20, the present invention is not limited to the aspect in another embodiment. An aspect may be provided in which the maintenance assistance device 2 according to another embodiment includes only any one of the monitor 21 and the buzzer 22 as the user interface, or includes a user interface other than the monitor 21 and the buzzer 22.

In addition, although the description is performed such that the maintenance assistance device 2 according to the first embodiment displays the remaining time for each consumable calculated in step S03 in FIG. 4 on the monitor 21 (step S04 in FIG. 4) and performs the alert process when remaining time is equal to or less than the predetermined value (step S06 in FIG. 4), the present invention is not limited to the aspect in another embodiment. For example, an aspect may be provided in which the maintenance assistance device 2 according to another embodiment simply displays the remaining time for each consumable on the monitor 21 and does not perform the alert process. On the contrary, an aspect may be provided in which the maintenance assistance device 2 according to another embodiment simply performs only the alert process without displaying the remaining time for each consumable on the monitor 21.

In addition, although the description is performed such that the maintenance assistance device 2 according to the first embodiment waits until the fixed time (for example, 30 minutes, 1 hour, or the like) elapses after calculating the remaining time for each consumable in step S03 of FIG. 4 (step S07 in FIG. 4), the present invention is not limited to the aspect in another embodiment. For example, an aspect may be provided in which the maintenance assistance device 2 according to another embodiment updates the remaining time for each consumable without waiting for the fixed time.

In addition, although the breaker BR is described as an example of one aspect of the attachment in the first embodiment, the present invention is not limited to the aspect in another embodiment. For example, the work equipment 12B according to another embodiment may be equipped with another attachment such as a crushing tool.

In addition, although the hydraulic excavator 1 is described as an example of one aspect of the work machine in the first embodiment, the present invention is not limited to the aspect in another embodiment. For example, the maintenance assistance device 2 according to another embodiment may be equipped with a wheel loader, which is an aspect of the work machine. Note that, an aspect of the attachment mounted on the wheel loader may be, for example, a grapple or the like used in a forestry site, a house dismantling, or the like. In this case, an operation of moving claws of the grapple to grab an object has a larger load on the consumable than the normal work (the work for excavating, loading, or leveling earth) performed by the wheel loader.

In addition, although the description is performed such that the maintenance estimate time calculation unit 203 according to the first embodiment calculates the “remaining time” as an aspect of the maintenance estimate time, the present invention is not limited to the aspect in another embodiment. The maintenance estimate time calculation unit 203 according to another embodiment may calculate, as the maintenance estimate time, for example, “used time” which is an accumulated value of a time during which the consumable is actually used. The used time is calculated by, for example, a sum of a value, which is obtained by multiplying (Current SMR−SMR at time of previous replacement) by the first coefficient α, and a value, which is obtained by multiplying (Accumulated value of current breaker use time−Accumulated value of breaker use time at time of previous replacement) by the second coefficient βIn this case, an aspect may be provided in which the notification processing unit 204 performs the alert process (step S06 in FIG. 4) when, for example, the calculated used time approaches more than or equal to the predetermined value to the replacement interval specified for the consumable.

In addition, as the maintenance estimate time, for example, a “maintenance period”, which is a period for the maintenance of the consumable, may be calculated. For example, the maintenance period is calculated by adding the remaining time, which is obtained using the above-described method, to a current date and time.

In addition, although the description is performed such that the maintenance assistance device 2 according to the first embodiment displays the “remaining time” on the monitor 21, the present invention is not limited to the aspect in another embodiment.

The maintenance assistance device 2 according to another embodiment may display the above-described “used time” on the monitor 21 or may display the maintenance period obtained by adding the “remaining time” to the current date and time.

In addition, an aspect may be provided in which the maintenance assistance device 2 according to another embodiment displays a state of the consumable by a change in a color. For example, the maintenance assistance device 2 according to another embodiment may display a color (for example, green) indicating that the state is good when the remaining time of the consumable is secured to be equal to or larger than the predetermined value, and may display a color (for example, red) indicating that maintenance is required when the remaining time of the consumable is equal to or less than the predetermined value.

In addition, in the first embodiment, an aspect may be provided in which the maintenance assistance device 2 normally displays the maintenance estimate time (remaining time table D2) on the monitor 21 while the hydraulic excavator 1 is operated.

However, in another embodiment, an aspect may be provided in which the maintenance assistance device 2 displays the maintenance estimate time only when the predetermined manipulation (a touch manipulation or the like performed on a determined button) performed by the worker is received. In this case, even when the maintenance assistance device 2 is in a state of not displaying the maintenance estimate time, the maintenance assistance device 2 may perform at least any one of issuing an alert by the buzzer 22 and displaying a caution by the monitor 21 when the alert process in step S06 in FIG. 4 is performed.

### (Computer Configuration)

FIG. 8 is a diagram representing a configuration of the controller according to the first embodiment and the modified example of the first embodiment as a computer.

A computer 99 includes a processor 991, a main memory 992, a storage 993, and an interface 994.

The above-described each controller 20 according to the first embodiment and the modified example of the first embodiment includes the computer 99. Each functional unit included in each controller 20 is stored in the storage 993 as a program. The processor 991 reads out the program from the storage 993 and deploys the program in the main memory 992 to operate according to the program, thereby exhibiting the functions as various functional units shown in FIGS. 2 and 3. The storage 993 is an example of a non-transitory medium. Another example of the non-transitory media includes an optical disk, a magnetic disk, a magneto-optical disk, and a semiconductor memory, which are connected through the interface 994.

Note that, in a power-off state, a general-purpose OS is previously recorded in a predetermined area of the storage 993. When the key-on manipulation by the operator is received, the CPU 991 operates according to a predetermined boot program to start the general-purpose OS.

The program may be delivered to the computer 99 via a network. In this case, the computer 99 deploys the delivered program in the main memory 992 and executes the above process. The program may be provided to realize a part of the above-described functions. For example, the program may realize the above-described function through a combination with another program already stored in the storage 993 or a combination with another program installed in another device. In addition, some of the above-described functions may be executed by another device connected via the network. That is, the above-described functions may be realized by cloud computing, grid computing, cluster computing, or another parallel computing.

The computer 99 may include a Programmable Logic Device (PLD) in addition to or in place of the above configuration. An example of the PLD includes a Programmable Array Logic (PAL), a Generic Array Logic (GAL), a Complex Programmable Logic Device (CPLD), and a Field Programmable Gate Array (FPGA).

Although some embodiments of the present invention are described hereinabove, the embodiments are presented as examples and are not intended to limit the scope of the invention. The embodiments can be implemented in various other forms, and various omissions, replacements, and changes can be made without departing from the spirit of the invention. The embodiments and modifications thereof are included in the invention described in the claims and equivalent ranges thereof as well as being included in the scope and the gist of the invention.

According to the present invention, it is possible to appropriately calculate a maintenance period even when a work which has a larger load than usual is performed with a mounted attachment.

1. A maintenance assistance device comprising:
an attachment use time acquisition unit configured to acquire a time during which an attachment is used, the attachment being mounted on a work machine and different from a bucket is used; and
a maintenance estimate time calculation unit configured to calculate a maintenance estimate time of a consumable equipped with the work machine based on the time during which the attachment is used.

2. The maintenance assistance device according to claim 1, wherein
the maintenance estimate time calculation unit is configured to calculate the maintenance estimate time of the consumable based on
a time during which the work machine is operated and
the time during which the attachment is used.

3. The maintenance assistance device according to claim 2, wherein
the maintenance estimate time calculation unit is further configured to calculate the maintenance estimate time by subtracting a first value and a second value from a maintenance interval of the consumable, the first value is obtained by multiplying the time during which the work machine is operated by a predetermined first coefficient, and the second value is obtained by multiplying the time during which the attachment is used by a predetermined second coefficient.

4. The maintenance assistance device according to claim 2, wherein
the maintenance estimate time calculation unit is further configured to calculate the maintenance estimate time based on
a first value obtained by multiplying the time during which the work machine is operated by a predetermined first coefficient and
a second value obtained by multiplying the time during which the attachment is used by a predetermined second coefficient.

5. The maintenance assistance device according to claim 2, wherein
the maintenance estimate time calculation unit is further configured to calculate
first maintenance estimate time of the consumable based on only the time during which the work machine is operated, and
a second maintenance estimate time of the consumable based on the time during which the work machine is operated and the time during which the attachment is used.

6. The maintenance assistance device according to claim 1, wherein
the attachment use time acquisition unit is configured to acquire the time during which the attachment is used by integrating an input time to a manipulation mechanism for the attachment by an operator.

7. The maintenance assistance device according to claim 1, further comprising:
a notification processing unit configured to notify a worker of the maintenance estimate time, wherein
the notification processing unit being further configured to notify of information indicating that the notified maintenance estimate time is calculated by considering a fact that the attachment different from the bucket is used.

8. A work machine including the maintenance assistance device according to claim 1.

9. A maintenance assistance system comprising:
an attachment use time acquisition unit configured to acquire a time during which an attachment is used, the attachment being mounted on a work machine and different from a bucket; and
a maintenance estimate time calculation unit configured to calculate a maintenance estimate time of a consumable equipped with the work machine based on the time during which the attachment is used.

10. A maintenance assistance method comprising:
acquiring a time during which an attachment is used, the attachment being mounted on a work machine and different from a bucket is used; and
calculating a maintenance estimate time of a consumable equipped with the work machine based on the time during which the attachment is used.
